(19) United States
(12) Patent Application Publication
(10) Pub. No.: US 2023/0351070 A1
(43) Pub. Date: Nov. 2, 2023

(54) SIMULATION-DRIVEN LOCALIZATION AND TRACKING OF PEOPLE

(71) Applicant: Armored Things, Inc., Sutton, MA (US)

(72) Inventors: Joshua A. Hartley, Amherst, NH (US); Christopher C. Lord, Natick, MA (US); Alexander T. Baker, Medford, MA (US)

(21) Appl. No.: 17/731,164

(22) Filed: Apr. 27, 2022

(51) Int. Cl. G06F 30/20; G06Q 30/00; G06V 20/52

(52) U.S. Cl. CPC G06F 30/20; G06Q 30/018; G06V 20/53; G06F 2111/08

(57) ABSTRACT

A computer-automated system and method derives occupancy information about a space—e.g., the location, counts, and movement of people within the space—from observations and predictions of a probabilistic simulation that is guided by sensor observations, but which is not dependent on these observations, and one in which all sensors collectively and emergently cooperate in the selection of occupancy information that best fits the observations.

The described system bears a resemblance to digital twins, but with fundamental differences in how the simulation operates and produces results, and without being overly concerned or restricted by maintaining physical equivalence in the model.

The simulation allows the system to provide estimates even when there are no direct observations and to incorporate a wide range of temporal information (including data from the past, present and future) and spatial information (size, structure, and use).

### BACKGROUND

It is desirable to model the occupancy of a space over time for a wide variety of reasons. For example, such modeling can be useful for predicting when a space will exceed its occupancy limit and thereby violate laws and/or create safety risks.

Existing techniques for modeling the occupancy of a space have a wide variety of drawbacks. For example, they may rely on the presence of extensive sensor data which is difficult or impossible to obtain over time. As another example, they may be limited to using only a single type of sensor, such as cameras. These and other limitations of existing systems cause them to produce models which are insufficiently accurate, especially when attempting to model the occupancy of a space at a future time.

What is needed, therefore, are improved techniques for modeling the occupancy of a space over time.

### SUMMARY

A computer-automated system and method derives occupancy information about a space—e.g., the location, counts, and movement of people within the space—from observations and predictions of a probabilistic simulation that is guided by sensor observations, but which is not dependent on these observations, and one in which all sensors collectively and emergently cooperate in the selection of occupancy information that best fits the observations.

This contrasts with sensor-based systems that use sensor fusion and established analytics techniques to produce an estimate of occupancy information directly from sensor data. In traditional systems, the results provided to users are largely summarizations of the sensor observations and are subject to the blindspots, inaccuracies and errors that each sensor introduces to the system.

The described system bears a resemblance to digital twins, but with fundamental differences in how the simulation operates and produces results, and without being overly concerned or restricted by maintaining physical equivalence in the model.

The simulation allows the system to provide estimates even when there are no direct observations and to incorporate a wide range of temporal information (including data from the past, present and future) and spatial information (size, structure, and use).

The information generated by the simulation may be useful to people and systems that need information about the location, count, and/or movement of one or more people or groups of people to perform their tasks or do so more effectively or efficiently. This includes:
Automating the technology in smart buildings, venues, campuses, and cities such as digital signage, building management systems, ventilation, lighting, power systems, fire systems, and security systems based on the presence, location and activities of people.
Determining or elucidating the decision-making actions of security and operations personnel responsible for the safety, security, sales, and experience of people, especially in the context of physical crowds and the movement, organization, and behavior of crowds.
Optimizing staffing, allocation, and returns on a space by providing predictive, realtime, and historical information on where people are, how long they occupy a space, and where they go afterwards to the patterns of life (understand journey paths, dwell time, congestion, entropy, flow rates, and directional change).

Embodiments of the present invention may be used to enable a variety of applications at scale or in commercial environments, such as the following:
1. Discovering the layout and organization of physical space. The system discovers the physical characteristics (e.g., ingress/egress, navigability, transitory, stationary) and constraints (e.g., density limits and flow directions and rates) through ongoing analysis of the movement of people across different sensor modalities. This allows the inference of occupancy across a larger space than is covered by any existing technology.
2. Tracking individuals and groups without sensor coverage. The system determines the composition of groups and identifies people so that their movements can be tracked over time and space through multi-modal fingerprints when they simultaneously present in different groups to overlapping detection technologies (e.g., video, infrared, wireless). This allows tracking when at least one of the sensor technologies is present.
3. Decoupling the sensing of space from the perceiving of occupancy. The role of simulation in the system isolates the sensing of space through instrumentation and the data produced from the perceiving of occupancy information in that space. This allows changes to be made independently to sensor configuration (location, types, capabilities) with minimal impact on how users view that space. It also allows users to change the way physical space is viewed or used—even retroactively—without corresponding changes to sensors.

Advantages of embodiments of the systems and methods of the present invention (also referred to herein simply as “the system” for ease of explanation) include the following:
1. Providing the strongest possible conclusions about the present and future locations of people and making estimates about those present and future locations in ways that are not otherwise possible.
   a. The system is resilient to inaccuracy, variability, and delays in measurement and the detection of people in a multi-sensor environment. Since data is not used directly, but as a way of selecting a highly probable simulation state, missing data is supplied by simulation, and inaccurate data is balanced and moderated by the selective force of all other data sources.
   b. The system supports high-trust and mission-critical applications by quantifying the uncertainty of the estimated results. Applications that require a high degree of certainty such as the control of life safety or alerting systems can be conditioned on the necessary level of certainty in the results, while less certain results can inform other operational activities.
   c. The system provides results that are explainable, in contrast to most machine learning systems. The system achieves its results by using sensor data and external data sources as evidence to select from a multitude of possible explanations produced by simulation. The results are self-consistent and necessarily fit the evidence.
2. The system amplifies the spatiotemporal capabilities of sensors to cover more space and extract occupancy features not detectable by the sensors themselves such as dwell and flow.
   a. The system learns the layout and characteristics of space over time through confirmed predictions of where people are—and where they are not—and can use this information to produce approximate maps of the space.
   b. The system provides the occupancy in spaces that are not covered by sensor technology or are partially or occasionally occluded from detection by inferring where people should be between sensor locations and observations.
   c. The system tracks the position of individuals and groups of individuals when identification is not consistently available across sensors or space by leveraging features of each sensor technology and mining overlapping and individual observations over time.
3. The system isolates the sensor view of the physical world (the sensing side) from the user view of the physical world (the perceiving side) and allows each to be specified incrementally and independently of each other.
   a. The system provides faster, simpler deployments of the technology without the burden of up-front mapping, markup, training, and annotation of the physical space.
   b. The system allows sensors to be changed, relocated, or added while continuing to provide consistent results. Similarly, it allows users to change how they configure or use a space independent of sensor locations.
   c. The system provides the retroactive reconfiguration of space to see how occupancy would look through a different “lens” at an earlier point in time and enables true what-if scenario planning and after-action review under actual and theoretical conditions.

The advantages described above and elsewhere herein are merely examples. Embodiments of the present invention may have other advantages as well. Furthermore, not all embodiments of the present invention may have all of the advantages described above and elsewhere herein.

Novel features of embodiments of the present invention include the following:
1. The system harnesses the collective capabilities of all sensors simultaneously to handle the limitations of sensors and data that undercut the capabilities of other systems. The system:
   a. Detects people in spaces without any direct observation through the selective pressure of other sensors and the elimination of possible simulation states that are inconsistent with available sensor observations. Once one or more people are known to be present, by direct detection or otherwise, inferences may be made about their possible previous or later locations in the space, even during times when they were not directly observed.
   b. Handles imprecision and inaccuracy in detection, and inconsistency and error in data collection (missing, late, or corrected) by having all sensor observations considered holistically in choosing simulation states that best (but may not completely) fit. For example, if there are 20 people in a room and none in the hallway at time t and at time t+1 there are five in the hallway but no sensor data from the room, the system would likely still show 15 people in the room because that would be a state that was consistent with the observation that there are five people in the hallway.
   c. Identifies people and flows even when individuals are not within the coverage of sensor types that can identify people by using earlier co-observations with identifying sensors and partially overlapping sensor coverage.
2. Predicts current and future state of occupancy information and emergent phenomena that cannot be discovered through existing methods by combining information from different points in time (past, present, and future), knowledge of space, and external context. The system:
   a. Provides a generalized way to represent the spatiotemporal capabilities of different sensor types, express spatial knowledge, and incorporate external influences and context so that models (or aspects of models) can be shared across different environments.
   b. Projects future scenarios that may not have been previously observed. For example, a late train arrival at a baseball game with an active weather delay on a weeknight will result in crowding at the gate despite none of this being explicitly modeled or observed in the past.
   c. Predicts the phenomena or event that might be occurring in a given space even when there is no context that identifies such an event and no prior training data to predict such an event. In effect, the system should be able to assert that a baseball game is happening given just sensor observations.
   d. Allows the retroactive updating of state when there is new context or late-arriving context.
3. Treats the sensor space independent of how the user views the same space so that occupancy information aligns with needs and not sensor coverage or physical boundaries. The system:
   a. Starts with partial knowledge and specification of physical spaces or sensor locations and can learn additional implications and function of space from observations so that, for example, ingress and egress points can be inferred from the traversability patterns of a space.
   b. Supports different perspectives needed by different user personas, usage profiles in a unified manner and with the same data. For example, the layout applied for the needs of HVAC is very different from the layout applied for a hot desking corporate environment, even though both require occupancy information in the same physical boundaries. The system produces results that can satisfy both.

The novel features described above and elsewhere herein are merely examples. Embodiments of the present invention may have other novel features as well. Furthermore, not all embodiments of the present invention may have all of the novel features described above and elsewhere herein.

### BRIEF DESCRIPTION OF THE DRAWINGS

FIG. 1 is a diagram of a system for generating a representation of predicted occupancy in a particular space according to one embodiment of the present invention.

FIG. 2 is a flowchart of a method performed by the system of FIG. 1 according to one embodiment of the present invention.

FIG. 3 is a diagram illustrating processing of various data sources into final estimates of occupancy of a space according to one embodiment of the present invention.

FIGS. 4A-4E are diagrams illustrating occupancy of a plurality of spaces at two different times according to one embodiment of the present invention.

FIGS. 5A-5G are illustrations of likely paths and double-counting detecting correlations according to one embodiment of the present invention.

FIG. 6A is an illustration of the possible locations of two tags over the course of five time steps according to one embodiment of the present invention.

FIG. 6B is an illustration of the identity path resulting from joining tags' data according to one embodiment of the present invention.

### DETAILED DESCRIPTION

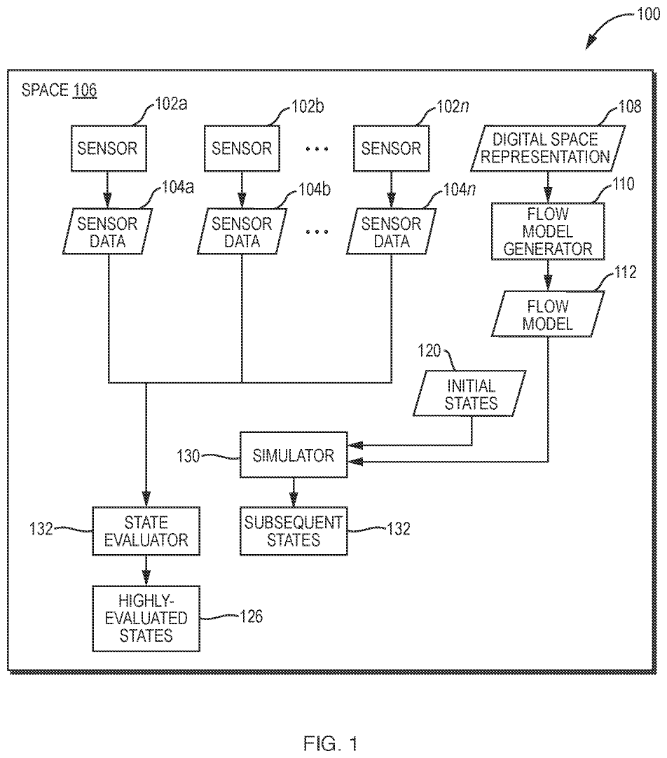

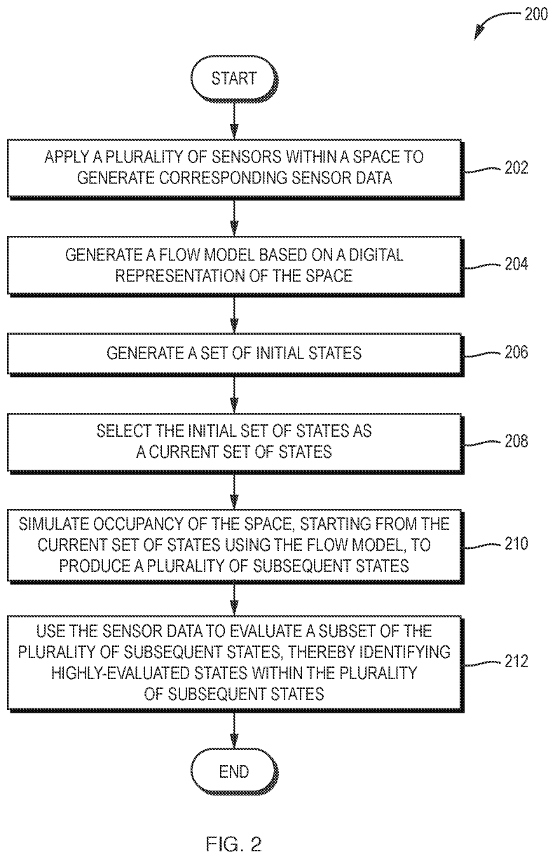

Referring to FIG. 1, a diagram is shown of a system 100 for generating a representation of predicted occupancy in a particular space according to one embodiment of the present invention. Referring to FIG. 2, a flowchart is shown of a method 200 performed by the system 100 for generating a representation of predicted occupancy in a particular space according to one embodiment of the present invention.

The system 100 includes a plurality of sensors 102a-n. Although three sensors are shown in FIG. 1 for ease of illustration, the system 100 may include any number of sensors (i.e., n may be any number). Furthermore, the sensors 102a-n may include sensors of any of a variety of types, in any combination.

The system 100 includes a space 106. Although the sensors 102a-n are illustrated in FIG. 1 as being within the space 106, and this may be the case, some of all of the sensors 102a-n may be located outside the space 106. Any one or more of the sensors 102a-n may, for example, be located outside the space 106 but sense matter and/or energy within the space, or which originated in the space 106 but which is sensed outside of the space 106, or which originated outside of the space 106 but may be associated with a person or object that can be conjectured to be inside space 106 at a previous or future time. Any one or more of the sensors 102a-n may be within the space 106 at some times and be outside the space 106 at other times. Any one or more of the sensors 102a-n may sense an area not physically located within the space 106 (whether the sensor itself is within the space 106 or outside the space 106), and the sensor data generated by such sensors may include data that indirectly indicates occupancy in the space 106.

The method 200 reads the plurality of sensors 102a-n within the space 106, thereby generating corresponding sensor data 104a-n (FIG. 2, operation 202). As shown in FIG. 1, sensor 102a generates corresponding sensor data 104a, sensor 102b generates corresponding sensor data 104b, etc.

Each of the sensors 102a-n may perform its sensing operation, and generate its corresponding sensor data 104a-n, at a particular time and while that sensor is located at a particular location. Some or all of the sensors 102a-n may perform additional sensing operations at additional times, thereby generating additional corresponding sensor data 104a-n. As a result, the sensor data 104a-n may include, for each of some or all of the sensors 102a-n, a plurality of units of sensor data, resulting from sensing operations performed at a plurality of corresponding times. Similarly, some or all of the sensors 102a-n may move from one location to another location (inside the space 106 or outside the space 106) any number of times, and may perform sensing operations at some or all of those locations to generate sensor data. As a result, the sensor data 104a-n may include, for each of some or all of the sensors 102a-n, a plurality of units of sensor data, resulting from sensing operations performed at a plurality of corresponding times.

Consider, for example, sensor 102a. At time T₁, sensor 102a may be located at location L₁, and may perform a sensing operation to generate sensor data associated with time T₁ and location L₁. At a subsequent time T₂, (i.e., T₂>T₁), sensor 102a may be located at location L₂, which may be the same as or differ from location L₁, and may perform a sensing operation to generate sensor data associated with time T₂ and location L₂. The same is applicable to any number of times and locations of sensor 102a. More generally, the same is true for all of the sensors 102a-n. As a result, the sensor data 104a-n may be associated with a plurality of times and locations.

The method 200 may use a flow model generator 110 to generate a flow model 112 based on a digital representation 108 of the space 106 (FIG. 2, operation 204). The flow model 112 may include traversability patterns representing the flow of people into, out of, and within the space 106 over time.

The method 200 may generate a set of initial states 120 (FIG. 2, operation 206) and select the set of initial states as a current set of states (FIG. 2, operation 208).

The method 200 may use a simulator 130 to simulate occupancy of the space 106, starting from the current set of states and using the flow model 110, to produce a plurality of subsequent states 124, wherein each of the plurality of subsequent states 124 indicates a corresponding estimation of the distribution of occupancy within the space 106 (FIG. 2, operation 210).

The method 200 may use the sensor data 104a-n to evaluate a subset of the plurality of subsequent states 124, wherein the estimations of occupancy corresponding to the subset of the plurality of subsequent states 124 are associated with a plurality of times and spaces that are not within the times and spaces associated with the sensor data 104a-n (FIG. 2, operation 212). The method 200 thereby identifies highly-evaluated states 126 within the plurality of subsequent states 124.

The method may further include providing the highly-evaluated states 126 as a current set of states to the simulator 130, repeating operations 210 and 212, and outputting the highly-evaluated states 126 produced by the most recent iteration of operation 212. Outputting the highly-evaluated states 126 may include one or more of the following, in any combination:
generating, for each of the subsequent states 124, a probabilistic certainty of that state representing an actual state of the space 106's occupancy;
providing a human-interpretable representation of a most likely actual occupancy of the space 106;
providing a representation of a likely actual occupancy of the space 106 as soon as sufficient data is available;
providing a representation of a likely actual occupancy of the space during a particular time period retroactively, based on data that arrived before, during, and after the particular time period;
providing a representation of a plurality of possible occupancies of the space 106; and
providing a representation of the system's probabilistic certainty about one or more possible occupancies of space 106.

The sensors 102a-n may be applied (in operation 202) to generate the sensor data 104a-n before operations 204-212 are performed, and the operations 204-212 may be applied to the sensor data 104a-n generated in operation 202, and not to any additional sensor data. As this implies the simulator 130 may generate the subsequent states 124, and the state evaluator 130 may generate the highly-evaluated states 126, based on the sensor data 104a-n that was generated before operations 204-212, and not based on any additional sensor data.

As some particular non-limiting examples of the sensors 102a-n and the sensor data 104a-n:
The sensors 102a-n may include one or more video cameras, and the sensor data 104a-n may include: (1) a plurality of images output by the one or more video cameras; and (2) locations of detected people in the plurality of images, as generated by analytics run on the plurality of images.
The sensors 102a-n may include one or more Wi-Fi-sensing sensors, and operation 212 may include using the plurality of images output by the one or more video cameras, the locations of detected people in the plurality of images, and Wi-Fi signal data from the Wi-Fi-sensing sensors to evaluate the subset of the plurality of subsequent states.
The sensors 102a-n may include one or more RFID sensors, and operation 212 may include using the plurality of images output by the plurality of video cameras, the locations of detected people in the plurality of images, and tag detection from the at least one of the RFID sensors to evaluate the subset of the plurality of subsequent states.
The sensors 102a-n may include one or more Wi-Fi access points, and the sensor data 104a-n may include one or more of: (1) data about communication of at least one device with one or more of the Wi-Fi access points; and (2) data about Wi-Fi signals detected by one or more of the Wi-Fi access points.
The sensors 102a-n may include one or more RFID sensors, and the sensor data 104a-n may include data, generated by one or more of the RFID sensors, about nearby RFID tags.
The sensors 102a-n may include one or more motion sensors, and the sensor data 104a-n may include one or more motion detection events generated by one or more of the motion sensors.
The sensors 102a-n may include one or more carbon dioxide sensors, and the sensor data 104a-n may include one or more carbon dioxide readings generated by one or more of the carbon dioxide sensors.
The sensors 102a-n may include one or more sound sensors (e.g., microphones), and the sensor data 104a-n may include one or more sound level readings generated by one or more of the sound sensors.
The plurality of sensors 102a-n may include one or more ultra-wideband sensors, and the sensor data 104a-n may include object detection data generated by one or more of the ultra-wideband sensors.
The plurality of sensors may include one or more access control badge sensors, and the sensor data 104a-n may include one or more budget detection events generated by one or more of the badge detection sensors.

For each of a plurality of types of sensors (such as the types of sensors described above), the system 100 may include zero, one, or more sensors of each sensor type. As this implies, the system 100 may include one or more sensors, each of which may be a sensor of any type (such as any of the types of sensors described above). As this implies, the system 100 may include a plurality of types of sensors, including one or more of each of the plurality of types of sensors, in any combination. Any such sensor may be distributed inside and/or outside the space in any spatial distribution. As part of evaluating the subset of the subsequent states 124, the state evaluator 130 may, for example, do one or more of the following, in any combination:
use the sensor data 104a-n, and data about one or more events that are planned in the space 106, to evaluate the subset of the subsequent states 124;
use the sensor data 104a-n and one or more predictions about weather at the space 106's location to evaluate the subset of the subsequent states 124;
use the sensor data 104a-n, and a plurality of environmental sensors providing readings of, for example, temperature, humidity, and light levels in space 106, to evaluate the subset of the subsequent states 124;
use the sensor data 104a-n and one or more public transportation schedules governing arrivals from and departures to locations near the space 106 to evaluate the subset of the subsequent states 124.

As part of generating the flow model 112 in operation 204, the flow model generator 110 may generate a graph representing the space 106, with graph nodes representing locations in the space 106 and links between them representing the ability for people to move from one location to another in the space 106. The flow model 112 may include a uniform representation of the space 106, which locates data from one or more of the sensors 102a-n with different spatial coverage and sensing capabilities. The data from these sensors is fused in the evaluation performed by the state evaluator 132 in operation 212. The flow model 112 may include a sensor-agnostic representation of the space 106, which enables the evaluation performed by the state evaluator 132 in operation 212 to be performed independently of limitations of individual ones of the sensors 102a-n.

The simulation performed by the simulator 130 in operation 210 may include simulating the occupancy of the space 106 using Sequential Monte Carlo simulation. The simulation performed by the simulator 130 in operation 210 may be informed by prior knowledge about qualities of the space 106 and similarities of the space 106 to previously analyzed spaces other than the space 106. The simulation performed by the simulator 130 in operation 210 may be informed by hyperparameters derived from offline simulations (which may be performed before operation 210) that model individual, artificially intelligent agents that move within the space 106. The simulation performed by the simulator 130 in operation 210 may be informed by hyperparameters modeling human, machine, or machine-assisted validation of occupancy of the space 106.

Producing the plurality of subsequent states 124 in operation 210 may include applying a probability distribution describing likely movements of people between locations in the space 106. The probability distribution may incorporate prior knowledge (e.g., knowledge obtained before operation 210) about how people enter and leave the space 106. The system 100 and method 200 may generate (e.g., before operation 210) the probability distribution based on one or more of the following, in any combination: (1) prior knowledge about maximum flow rates that are possible between areas in the space 106; (2) prior knowledge about occupants' typical goals and preferred navigation paths in the space 106; and (3) prior knowledge about how any addition or removal of an impediment to movement in the space (e.g., crowding, arrangement of furniture, or locking of a door) affects occupants' possible movements in the space 106.

As part of evaluating the subset of the subsequent states 124 in operation 212, the state evaluator 130 may find a joint probability distribution of the subsequent states 124 and an observation probability distribution that summarizes the sensor data 104a-n. As part of evaluating the subset of the subsequent states 124 in operation 212, the state evaluator 130 may combine information about individual occupants' likely locations in the space over time with anonymous data within the sensor data 104a-n.

Having just described certain embodiments of the present invention at a high level, various ways of implementing certain embodiments will now be described in more detail. Embodiments of the present invention provide real-time, historical, and predictive estimates of occupancy in a monitored space. This may be achieved, for example, using three technological methods:
A process for creating digital twin representations of the monitored space that encode physical and behavioral constraints
A design for probabilistic state space models that describe how people are arrive, depart and move through the monitored space
A simulation using Sequential Monte Carlo (SMC) to explore various possible occupancy scenarios and extrapolate insights beyond what can be directly observed in the monitored space

Advantages of embodiments of the present invention over other attempts to solve the same problem include that they are:
Capable of fusing data from many different sensor types. In particular, embodiments of the present invention employ a novel method for deriving insights from data sources where people can be identified over time. This results in far more accurate occupancy estimates.
Capable of inferring the locations of people, even if they are not directly detected by sensors in a particular time and place.
Capable of making estimates despite missing, delayed, or wrong data from one or more sensors.
Able to flexibly incorporate prior knowledge about spaces and leverage this knowledge to make more accurate estimates.
Able to provide users with a measure of its certainty about its estimates, enabling greater confidence in the system and an improved ability to act on its conclusions

The remainder of this detailed description focuses on four main areas:
Terminology
Models of physical spaces
Data sources
Simulation

### Terminology

To aid in understanding the various embodiments of the present invention, below is a glossary of terms used herein:

Property—refers to the entire region that an embodiment of the present invention is attempting to analyze. This may include, for example, one or a plurality of spaces (such as one or a plurality of buildings).

Space—refers to a sub-region that embodiments of the present invention analyze. Each space may, for example, be a single floor in a building or a single contiguous outdoor region, and may be capable of being rendered and analyzed as a two-dimensional map with little loss of fidelity. Spaces may also be sub-regions of such floors or regions, for example, one or more rooms, hallways, or zones. Spaces may also refer to multiple floors or discontiguous regions.

In more technical terms, each space may, for example, be a cartesian plane georeferenced in meters. People may leave one space on a property and enter another, and each such space may be governed by a self-contained analysis process. This may be necessary to make simulation computationally tractable. It also aligns with familiar usage patterns where people interact with and receive insights about a single map's-worth of information at a time. However, activities in one space may still affect other spaces. For example, if two spaces are physically near one another, the fact that people have left one space may be used to infer that those people have arrived in the other space, and the analysis of the latter space may be influenced accordingly.

Map—refers to any visual, human-consumable representation of a space. This reflects that 2D and 3D maps are the most common abstraction of spaces that people interact with, whether they are looking at a map of a college campus or a hotel fire safety map. A map will be one-to-one with a space and is an aspect of the digital twin representation.

Area—refers to sub-regions within a space or map. These may, for example, be contiguous regions that can be defined by a polygon drawn on a map, and may represent rooms, hallways, seating zones, or other areas of interest to the user or the system.

Asset—represents an area of interest to the user, and may refer to a property, a space, or an area of interest. Note that an asset is specifically required to correlate one-to-one with any other area that is used to provide prior knowledge to the analytics; it is purely a user-facing concept.

Estimate—any conjecture about the occupancy in an area in a space. It may have a varying degree of uncertainty, and may be about occupancy in the past, present or future. Types of estimates include:
Live: based on the most recent sensor data that has been received, intended to be reported to the user within a few minutes of it being detected.
Historical: estimates that leverage a longer period of time, for example considering data spanning an entire day, month, or year, These estimates may make statements about a given moment that are informed by events that occurred afterwards.
Projected: estimates about the near future in a given space, given the latest data from sensors and optionally considering contextual data such as weather and event schedules. These estimates may make predictions about events that are, for example, 30 seconds, 1 minute, or 10 minutes in the future.
Forecasted: longer-term estimates about larger-scale spaces, which leverage historical trends and optionally consider contextual data such as weather and event schedules. For example, these estimates may make predictions about what is likely to occur one hour, one day, one month, or one year in the future.

Finally, a few additional definitions with respect to the invention's data model:

Data Source—any system that provides insight into the current location of people in a space, optionally providing detail about their counts and direction of movement.

Sensor—any piece of hardware that contributes data to the occupancy analysis of a space. This includes sensors designed for detecting people, but also video cameras, Wi-Fi access points, and environmental sensors, which can be leveraged to provide insights helpful to embodiments of the present invention. Sensors will often be physically situated in the space itself, but may also be elsewhere and provide indirect insight into the space's occupancy.

Context Data Source—any system providing information that may inform patterns of peoples' use of the space, without actually observing them directly or indirectly. Examples include weather data, train arrival times, and event schedules.

Flow Model—the graph-based data model of occupancy in space that may serve as a common data structure for combining data from various sources, analyzing its implications. Where a map captures the physical representation of a digital twin, the flow model captures environmental and behavioral aspects. The graph representation that this model uses may be referred to as its network. This is similar to the more general concept of a digital twin.

State Space Model—a series of probability distributions that describe how one modeled state may lead to other subsequent states.

Simulator—an analysis model that considers a flow model representing a space and may draw conclusions based on data source observations. This analysis may, for example, be performed by applying Sequential Monte Carlo methods, and may, for example, be guided by a state space model.

### Creating Digital Models of Physical Spaces

Embodiments of the present invention use software to make practical insights about a physical space. This may include generating, storing, and updating a digital representation of that space that the software can reason about and analyze. This concept is often referred to as creating a digital twin of a space.

Note that this process is not simply the digitization of the physical aspects of the rooms, hallways, and other spaces. Digital representations used by embodiments of the present invention may serve as a bridge between several conceptualizations of a given space and may act as a common language for different data sources that otherwise would not readily be in conversation with one another.

Consider, for example, the following considerations that may be reflected in a particular digital representation used by embodiments of the present invention:
The end-user concept of space: consumers of the system's output will want insights to be delivered in terms of areas of interest. They may be interested in the length of a line in front of a desk or the utilization rate of a conference room, or whether a ballroom is above its maximum safe capacity. Such end-user spaces may be transient (tied to a one-time or recurring event) or permanent.
The knowledge concept of space: embodiments of the present invention may use human-supplied information about how a space can and should be used, which may, in turn, be used to inform estimates generated by embodiments of the present invention. This may be the maximum occupancy of a ballroom, which has a one-to-one mapping with the user's concerns. But this may also be an understanding of how long people tend to loiter in a coffee shop or knowledge about which parts of a seating area are exposed to the rain. These notions are not necessarily equivalent to rooms or other areas of interest to the user.
Sensor coverage: sensors report what they detect over a period of time with at least partially known rates and delays, but usually are not able to situate that reporting in physical space. Sensors will generally report some combination of the number, location, and movement direction of people they see, but these numbers will only be relative to the sensor's location.
Navigable space breakdowns: this is a cross-cutting concern about how areas are connected to each other and how people can move between them. For example, when sensors are added to all entrances and exits of a given area, embodiments of the present invention may detect counts within that area. But that conceptual area may not map one-to-one with an area that is directly interesting to the end-user, readily described by spatial knowledge, nor known to any individual sensor.

Embodiments of the present invention may model the space in a way that represents the output of disparate sensors and categories of sensing technology, physical boundaries, expected activity patterns, and the user's (sometimes changing) conceptualization of the space. Doing so may involve a series of modeling and algorithmic approaches.

As an example, a summary of one possible process for the creation of this digital representation according to embodiments of the present invention follows:
Several aspects of the physical space are indicated in terms of a bounded cartesian coordinate space, such as one or both of the following:
   Physical attributes of spaces
   Preliminary areas of user interest and knowledge
Each data source integration has its space of possible detection locations mapped to this coordinate space.
A representation of the locations that people can occupy in the space is algorithmically generated, forming the nodes of a flow model.
These nodes are connected with edges representing all possible human-traversable transitions between locations
The coordinate space may be grounded in absolute georeferenced coordinates The goal of this process is to create a unified data model, onto which areas of interest and data sources can be mapped, and which can be used to make inferences about the peoples' likely locations and movement patterns.

Cartesian Spaces

Cartesian spaces can be colloquially understood as digital versions of the building maps (consider a map of stores in a mall, or a fire escape plan map in a hotel). Such maps are generally roughly to scale, but they are abstractions: they are not constrained by any real geographical coordinate system. They may also be rotated in a way that creates more human-readable, orthogonal shapes, rather than aligning the top of the map to true north, the direction of the map on the wall, or any externally meaningful direction.

These cartesian spaces help enable a machine-assisted, semi-automated process of describing the spaces to be monitored. In particular:
This format simplifies the process of importing and leveraging existing models and representations of the space, such as blueprints, drawings, CAD files, and Building Information Models (BIM), each of which may have varying or non-existent concepts of geographic space.
The abstraction afforded by the cartesian spaces makes human input easier: the spaces can be presented in a way that is easily understood and annotated.

The main features that may be represented in this format include:
The areas that a user is interested in understanding as an output of the system
Areas that may be linked to external data sources, such as room reservation systems, maximum occupancy data stores, or event schedules
A plurality of polygons representing what parts of the space can be occupied by people
A probabilistic representation of which locations can be reached from others. One possible expression of this idea is a wall or other boundary, indicating that while two areas are both potentially occupied by people, it is not possible to move between them directly. Another example of a possible expression would be to indicate one-way movement between areas, for example representing turnstiles or other mechanisms designed to enforce such restrictions. Another example of a possible expression would be to indicate movements between locations that were possible but unlikely, for example across a restricted area.
Staircases, external doors, or other methods by which a person might enter or leave the space, which can be referred to as portals.
A numerical representation of how the abstracted distances in the map translate to real meters, enabling concepts such as maximum density and movement speed to be expressed in real terms, and then translated into map units

These cartesian spaces may be stored as shapefiles, or other common representations, enabling them to be interacted with via a variety of existing tools. Each space may be annotated to include Coordinate Reference System (CRS) details and stored in a georeferenced coordinate system. This may be done via any one of the existing map tools that depicts buildings in a geographical context and provide geospatial data, such as Google Maps. This information may be leveraged to project the entire cartesian space into the latitude and longitude space. This global coordinate system enables all specified information in each space to be compared to other spaces in the system, and to interface with external data sources that are specified in terms of that geographical space.

This final step is straightforward in the majority of cases including, for example, outdoor areas and the floors of buildings can be assumed to have a static geographic grounding. Embodiments of the present invention may also monitor the occupancy of dynamic spaces such as buses, cruise ships, and portable office trailers. In these cases, the georeferencing may be dynamically updated as the spaces move. However, this step may not be necessary to enable many of the system's benefits.

Flow Models

Each space is represented in the system by a flow model. This model may be represented by a graph of nodes and connections between them which has two main properties:
Each node in the network represents a distinct area in the space, and collectively the nodes' areas form a tessellation of that space (there are no gaps or overlap).
Nodes are connected if and only if a person could move from one node's space to the others' without crossing any physical boundaries or moving through intermediate nodes.

There are several ways that this network can be generated, such as, for example, the following:
Based on the total area of the space to be covered, generate a number of random points in the space
   Optionally, points that are very near each other may be removed. This may be done efficiently by indexing the points into a KDTree and using a radius search to find points near each point.
For each point, determine the distance to each nearby point.
   Candidate points that are across a wall boundary or otherwise unreachable from the source node are given an infinitely high distance value
   Once again, a data structure such as a KDTree can be used to efficiently find nearby points and prevent a computationally intractable number of comparisons
Use these distance values as inputs for an agglomerative clustering algorithm, which will create roughly evenly sized nodes based on these smaller points. Each such cluster will become a node in the flow model's network. Because the distances between the points are aware of the traversability between them, the nodes created by this process will not span traversability boundaries, ensuring that they represent cohesive areas of the space
The location of each node can be approximated in a number of ways, which may be useful in different contexts. One such method is:
   The centroid of each cluster is used to approximate the location of the node
   A voronoi tessellation of the centroids is used to approximate the boundaries of each node's area of coverage
   The locations of each node's individual points is compared to this tessellation, associating each point with exactly one node. This notion of node membership is used in the following step.
Create a link between each node and another node only if it contains a number of points that are nearby a certain number points in the other node. Because these distances are based on boundary data, the links between nodes will not cross boundaries, and traversability between the nodes can be safely assumed.

This description alludes to a few parameters that may be tuned to purpose:
The number of desired nodes is provided to the agglomerative clustering algorithm. A larger number will make for a more dense and computationally intensive network, but the density of points should be sufficient to ensure:
   Each area that is likely to be specified in the cartesian space contains one or more nodes.
   Similarly, each sensor can be spatially mapped to at least one node
   The nuances of the navigation through the space are captured by the edges between the nodes.
The number of points generated will be a function of the desired number of nodes, and will generally be 25-100 times higher to ensure effective generation.
The threshold distances and counts for determining network adjacency should be tuned to accommodate the geometric width of typical traversable spaces.

All of these parameters are effective within a wide range of values, can be algorithmically approximated, and are readily tuned as may be helpful to balance between resources and requirements.

As an illustration of the space of possible approaches, another method of clustering can be described as:
Generate random points (as above)
While there are unassigned points:
   choose a random point
   find all neighbors within a given distance of that point (using efficient algorithms as described above)
   use the initial point as the node center, mark all neighbor points as members of that node and remove them from future consideration

While this approach is prone to creating nodes with more irregularly-sized coverage areas, it has been shown to be effective in models of many real-world properties.

Note that nodes that are attached to portals, as specified in the model, will be flagged as such. These are nodes from which people might depart from or arrive at the space, which may be utilized by a simulation's transition distribution, to be discussed below.

Properties

The result of this examples process is a flow model that has the following important properties:
The node locations are agnostic of any specific use-case or data source's conceptualization of space.
The node locations may be specified in a cartesian space that maps to several conceptions of the spaces, including, for example, use-cases, knowledge, and data sources
The practical human occupancy and motion through the space may be modeled in terms of its nodes and edges.
The nodes may be grounded in a cartesian space that is linked to a geographic context, allowing for interactions with data outside that context.

As a final example, this means that, in a hypothetical map, a given node may have the following properties:
A camera may detect people and assign them to this node.
The node may be assumed to have a particular maximum occupancy, as derived from the amount of space the node represents, and a hyperparameter indicating a prior knowledge about the maximum density of people in a space.
People detected in the node may be assumed to have come from a bounded set of nearby, traversable nodes, and may be assumed to depart to a similarly bounded set (or to a nearby portal representing an exit from the space entirely).
When an embodiment of the present invention makes an estimate about the number of people occupying this node, that estimate may be combined with the estimated occupancy of other nearby nodes to provide insights about macro-scale areas which may be of interest to a user.

### Modeling Data and Data Sources

The following sections describe how data may be ingested and modeled to enable embodiments of the present invention to analyze the occupancy of a space.

Integrations

Each sensor used by embodiments of the present invention may report data from a physical location specified, most often (though not necessarily) in terms of a cartesian space. In addition, different integrations may have additional information to incorporate their detections into the map space. For example:
Wireless access points and other device-detecting sensors may report that they communicated with a given device, providing an indication that the device is nearby. Additionally, they may provide additional information. For example, they may include any combination of one or more of the following: information about the strength of the signal from the device, the timing of various data exchanges, or the type of connection attempted. These additional details may be analyzed to provide an improved estimate of the device's location. Furthermore, the layout of multiple such sensors may give additional insight. For example, the fact that a device connected to one sensor, and not another, may inform further inferences about the device's location.
In some embodiments of the present invention, no location of a person is directly indicated. Rather, a device's location may be inferred to be correlated with a person's location, for example, in the case where the device in question is a wifi-enabled phone which is carried by a person. In such a case, data about a potential person's location may be provided by an integration layer that incorporates the information outlined here, and optionally additional data, and outputs an estimate of a person's location.
Video analytics systems may analyze frames of video and identify people in each frame of video. Estimates of people's locations may be improved when the system is aware of the location and orientation of the camera itself. Estimates of people's locations may be improved when the system has information about how locations in the video frame map to a physical space. For example, a person detected in the top part of a camera frame may be known to be further from the camera than a person who is detected nearer the bottom part of the camera frame. When information of this kind is available, embodiments of the present invention may algorithmically generate a mapping that allows camera analytics detections to be correlated with locations in a flow model.
Close-range object detectors such as RFID readers may be positioned so that they are able to identify the location of a detected object and/or direction that a detected object is moving. The detection of the object may be inferred to correlate with a person carrying the object. The system may make inferences about the locations of people after objects have been detected, based, for example, on knowledge about the locations of the detectors and the constraints of the physical space that they are situated in. The translation of object detection data into person location data may be handled by a data integration layer.

The result of these integrations is that disparate data sources, which detect people differently and at varying levels of frequency and fidelity, may be brought together into a shared analytical space. This decoupling, along with the data source taxonomy described below, may enable embodiments of the present invention to combine data from multiple data sources more easily.

Data Types

One advantage of various embodiments of the present invention is that they are able to combine data from multiple disparate data sources. There are several important properties that describe data sources and that may inform how their output will be integrated by embodiments of the present invention. Together, these form a loose taxonomy of data types.

Identified vs Unidentified

Some sensors' data may be described as “identified”. This describes whether multiple person detections over time can be inferred to be of the same person, or whether each detection is anonymous and must be treated independently. Examples of identified sensors include:
RFID detectors, which generally use sensors to detect nearby RFID tags that people are carrying. Each tag reports a unique id to the sensor and is assigned to a single person for a period of time, enabling the inference of the same person over that period.
Wifi sensors that provide data about associated wifi connections: when a person connects to a wifi network, their phone may associate with various access points using a unique MAC address that has a likelihood of being consistent for the duration of that connection.
Bluetooth detectors, which provide data about Bluetooth tags. Each tag reports a unique device address and is assigned to a single person for a period of time, enabling the inference of the same person over that period.

In all cases there may be some uncertainty as to whether multiple detection events refer to a consistent individual, but the above examples have a low enough uncertainty that they may often be treated as identifying people. Examples of unidentified sensors, where there is very little certainty of consistent individual detection, include:
CO2 detectors, which infer the number of people in a room by the amount of CO2 detected, implying more people
People counters, which use passive infrared (PIR), lasers, or low-quality imaging to detect motion or presence in a space, implying the presence of one or more people

There are also data sources which could potentially identify people, but where identification is less certain than in the case of data sources labeled “identified”, and which embodiments of the present invention may treat as identified or unidentified. For example:
Wifi access points may be capable of detecting peoples' devices based on probe requests and other passive signals, even if they are not connected to the network or associated with the access point. But device identities may not be consistently reported as part of this process due to techniques such as MAC address randomization.
Video detection technology may be capable of identifying individuals through facial recognition or other methods. But these methods may not be reliable across different detections, and embodiments of the present invention may perform better by treating this data source as unidentified.
Bluetooth sensors may provide data about Bluetooth devices that are within proximity to the sensor through passive signals emitted by devices and through techniques such as public polling. Like wifi, device identities may not be consistently reported as part of this process due to techniques such as device address randomization.

Position and Flow Detecting Capabilities

Sensors used by embodiments of the present invention may be capable of providing some information about a person's location. In some cases this may be very precise; for example an RFID detector that detects an RFID tag may be used to infer that a person is fairly near the detector. In others the location may be less certain: devices may connect to wifi access points from quite a long distance away, and the location of a device (and therefore the person carrying it) might only be inferred with a high degree of uncertainty.

In some cases, beyond a location, a sensor may be able to provide data that helps to infer the direction of a person's movement. This information may be binary, perhaps indicating whether a person is “entering” versus “exiting” through a doorway. In other cases, a more nuanced vector of movement can be derived, enabling the direction and/or speed at which the detected people are moving to be inferred. In these latter cases, this additional information may be used by embodiments of the present invention to model the flow of people, and thereby to make more accurate evaluations of the occupancy in a space.

Direct vs. Indirect Detection

Some sensors directly detect people, while others detect conditions that indicate the presence of people. For example, video analytics systems are often designed to detect images of people in video frames; this may be considered direct detection. In the case of CO2 sensors and motion detectors, for example, CO2 and motion are detected, respectively. These phenomena may be inferred to correlate with the presence of people, but there may be an increased chance that the detected phenomena may be caused by spurious factors other than the presence of people. In the case of RFID, Bluetooth, IoT, and Wifi-based sensors, sensors detect identifiable objects or tags that may be carried by people. But each such detection does not necessarily correlate to a person at the object's location: people may carry more than one such device, or may carry such devices temporarily. In addition, some sensors may be outside the space being monitored but inform its past, present, or future occupancy. For example, a sensor detecting the number of cars in a parking garage may inform the number of people who are about to arrive, or who recently departed, a nearby area.

In each case, these data sources introduce an element of uncertainty that embodiments of the present invention may accommodate. This can broadly be handled by, for example, hyperparameters that influence probabilistic assessments of occupancy, and which may be used to model this uncertainty. In the case of sensors that detect objects, embodiments of the present invention may use a system of tags, which can be used to make holistic inferences about how these detections correlate with people; this is discussed in more detail in a later section.

Embodiments of the present invention have the ability to handle this variety of data sources. This is enabled by the following capabilities that will be discussed below:
considering of an arbitrary number unidentified data sources
converting multiple identified data sources into a single aggregated data source, which can be treated as if it was unidentified while retaining the useful underlying information
using hyperparameters and modeling uncertainty to manage sensors' location imprecision and indirection issues
using Sequential Monte Carlo-based simulation to:
   take advantage of directional flow information provided by some data sources
   effectively fuse information from data sources with differing temporal cadences

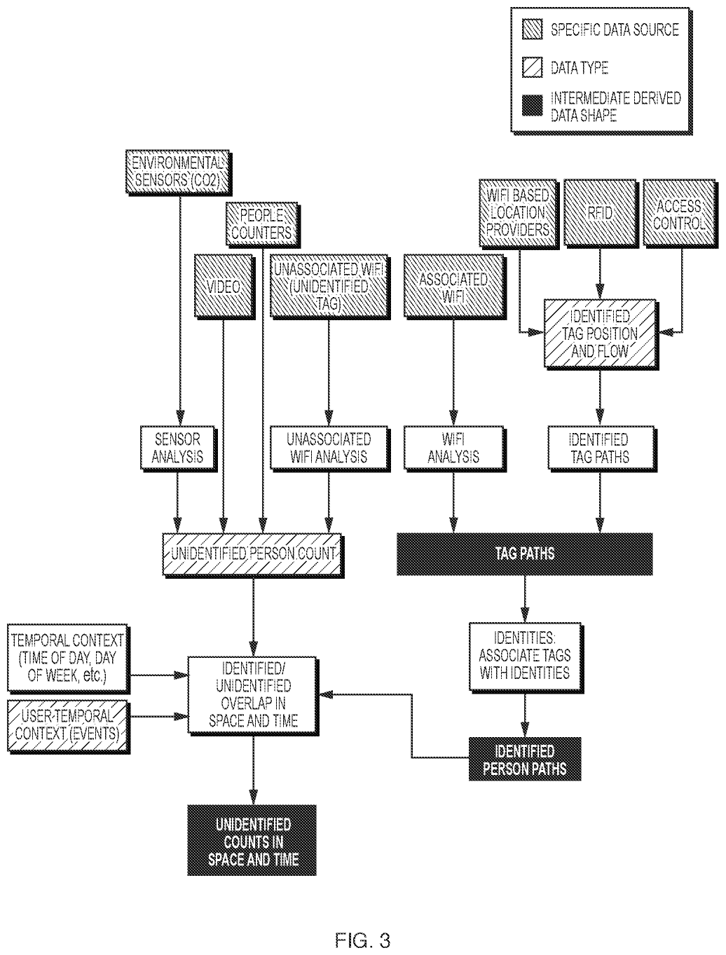

FIG. 3 illustrates a summary of how various specific data sources (in the top row of FIG. 3) are processed and combined into a final set of estimates. Note that identified data sources demand several additional analysis steps, which are detailed in a dedicated section below.

### Simulation

Embodiments of the present invention include a simulator, which captures the flow of people between spaces over time. This section describes how this simulator may be implemented.

Sequential Monte Carlo Methods

The simulator may, for example, use a Sequential Monte Carlo (SMC) method. In addition, SMC may be used to address secondary analysis problems that support the core simulator.

In general, Sequential Monte Carlo methods serve to determine the likelihood of possible hidden states given incomplete, potentially error-prone observations. Various embodiments of the present invention that apply this approach may consider the hidden state to be the actual occupancy of a space, and sensor data may represent the observations used to determine states' likelihood. Other contextual and non-sensor data may also be used to influence states' likelihood.

Various embodiments of the present invention that apply Sequential Monte Carlo methods may use a state space model to represent a plurality of hypothetical occupancy states. They may specify transition distributions for generating future hypothetical occupancy states based on previous hypothetical occupancy states. These embodiments may, for example, apply the bootstrap Sequential Monte Carlo method or guided Sequential Monte Carlo method, which respectively ignore and consider observations when generating these hypothetical states. They may also specify observation distributions for evaluating observations relative to hypothetical occupancy states.

Sequential Monte Carlo methods support carrying multiple possible hypothetical states forward through the analysis process. Various embodiments of the present invention that apply this approach may take advantage of this property, maintaining multiple alternative hypothetical occupancy states, ensuring that a “dead end” is not reached when additional sensor data is received.

Various embodiments of the present invention that apply Sequential Monte Carlo methods may use Sequential Monte Carlo's notion of filtering, using it to determine which possible assessments to continue to analyze in subsequent iterations of the simulation, as well as to make live estimates of occupancy. Sequential Monte Carlo's notion of smoothing, which takes into account future states, may be used to make historical estimates. Allowing the Sequential Monte Carlo simulation to run forward without additional sensor data may be used to inform projections about future states.

Having established the generalized notion of state space models and application of sequential Monte Carlo methods, we now describe how embodiments of the present invention generate and use state space models of monitored spaces. These state space models may be based on principles generalized across all users and properties, made specific to a given space via the details of a flow model, and used as inputs to a Sequential Monte Carlo method.

The Importance of Anonymous Occupancy

The space of possible states in the simulator may need to remain practical in size so as to be effectively computed. The main practical implication of this is that embodiments of the present invention may avoid modeling individual people in any way and treat people as independent and interchangeable.

The following sections detail the distributions that may be used in state space models that may enable various embodiments of the present invention.

State Space Model: initial Distribution

The initial space distribution may be generated in any of a variety of ways, such as the following:
Generate a distribution of possible total numbers of people, based on a prior understanding of the maximum occupancy of the space
Across this distribution, uniformly distribute that number of people within the navigable areas in the space

Many of the initial realities generated by this will be wholly incorrect in their count and placement of people, but within a small number of iterations, the likelihood distribution will cause the generated state spaces to gravitate towards the realities suggested by the data. The creation of initial states may be guided by heuristics based on current data source observations. This would serve to select more-informed initial counts and locations for an initial state, though this may be redundant with the effect that running the particular filter for several steps is meant to achieve.

State Space Model: Transition Distribution

There are three important components of the transition distribution in a space being analyzed. It is meant to generate possible realities reflecting:
how people might move between locations
how people from outside the space might arrive, growing the space's occupancy
how people might leave the space: departures may be treated as a subset of possible movements (available only in locations near portals out of the space) or they may be modeled more overtly in terms of how long people tend to dwell in the space

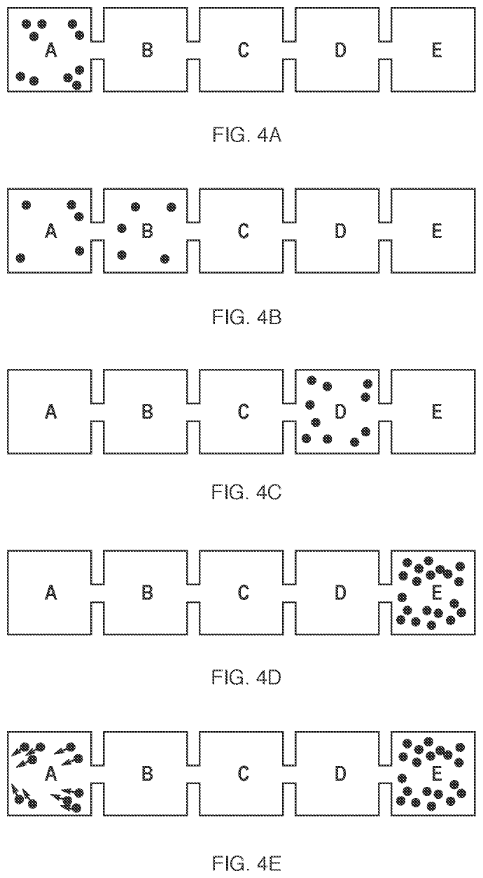

The first case of movement (and in the reduced form, the third case of leaving) is based on the traversability edges in a space's flow model. Because of the flow model's embodiment of knowledge of how each node can be reached from other nodes, it can be used to guide the generation of new realities. For example, consider a hypothetical space consisting of five large rooms, named A through E, as shown in the FIG. 4. In a hypothetical current state wherein there are 10 people in room A, the distribution might suggest that, given a behavioral understanding of how fast people can walk and the size of the rooms, that in the next state:
10 people remaining in room A (as illustrated in FIG. 4A) is likely
5 people remaining in room A and 5 people are now in room B (as illustrated in FIG. 4B) is somewhat likely
10 people ending up in room D (as illustrated in FIG. 4C) is very unlikely
20 people residing in room E (as illustrated in FIG. 4D) is exceptionally unlikely

A scenario where all 10 people in room A move to room D is potentially possible, it will simply be generated less often by the probability distribution, and will tend to have less prominence in the set of generated realities.

The arrival distribution of our transition distribution can also be considered. Because any practical analysis of occupancy will have a finite spatial scope, there is always the possibility that a person who was not previously within the scope of the simulation's analysis will enter that scope. In this case, the simulation will have no previous knowledge of or ability to simulate such a person. A person who enters the scope of the simulation in this way can be said to have arrived via a portal. A portal may be outside the physical space being monitored, but this section will describe portals as being in the space being monitored for clarity.

The probability distribution describing how such people arrive at various portal-adjacent locations (which are modeled as nodes in a flow model) may be assumed to be uniform over time, or might be informed by time of day, schedules, or historical precedent. As a baseline solution, a Poisson distribution centered around a reasonable number of people given the estimated usage rate of the space may be used. An inflated negative binomial distribution may also be used to reflect the non-uniform nature of peoples' arrivals.

As an illustration of the role of this component of the transition distribution, consider the previous five-room scenario: if rooms A and E were both connected to portals, it is possible that the 10 people in room A left the space, and that 20 different people arrived at the space via the portal in room E (as illustrated in FIG. 4E). The eventual likelihood of this possibility would depend on observations from data sources, which will be addressed in a later section.

In the following sections, three additional approaches that may inform how a simulation may iterate on possible states are explored.

Departure Rates

In practice, people don't tend to be in constant motion: some locations are destinations where people are inclined to, for example, sit down to eat, attend a class, or wait in a slow-moving line. Such locations may be modeled in embodiments of the present invention as areas in a network flow model, and the distribution of how long people are modeled to stay in an area may be based on prior knowledge about activity patterns common to the area. These area-based distributions may be applied to nodes corresponding to the specified area in the flow network, and may be used to probabilistically determine the number of simulated people in a node who should leave the node at a given time step.

Once a distribution of time spent in a node is established, there is the matter of applying that distribution to change a node's occupancy over time. Modeling individuals' time spent in a node may appear to be a solution, but this would require modeling individual people in the simulation (which is undesirable, as discussed in a previous section). The simulation may instead model a per-node distribution of how many people should leave each node, which is updated over time, which effectively approximates the process of modeling individuals' time spent in the node. One example of such an approach is:
Each node has an individual departure distribution: this is a distribution over time, relative to the time that a person arrived, that they will depart the space. This is derived based on (1) the distribution defining how long people might wish to stay in the node's area, and (2) the time to move through this node based on the movement speed. The result of these two factors is a bimodal distribution capturing the possibility of movement or staying stationary in the space. This models, for example, the fact that some people may be walking through a cafeteria on their way to somewhere else, while some may be staying for lunch.
Individual departure distributions are not separately maintained as part of a state, but rather are used to calculate a total departure distribution that is the sum of the departure probability of individuals that arrived in previous time steps. Whenever a person arrives in the space, a new individual departure distribution is added to this total distribution.
At each time step, the current value of the total departure distribution is divided by the number of individuals in the space to be used as the average probability of departure. The number of people departing at a given time step is a draw from a binomial distribution based on this average probability and the number of people in the space.
At the end of each time step, the total departure distribution for a node is rotated to remove the current time step value and slide the distribution forward in time.

The result is a distribution that is influenced by individuals' behaviors and models longer-term visits to spaces in an emergent way, without introducing the complexity of tracking individuals.

A similar principle may also be applied to peoples' departures from the space altogether. There may be a natural duration to a person's visit to a particular space that can be modeled in the flow network. A distribution that governs how many people near portals should depart via those portals may be found by recreating the process described above at a global scale for an entire space. This distribution would serve to offset the arrivals that periodically occur via the arrival distribution.

Navigation Likelihood

Once the number of people who will leave a node during a time step has been determined, the navigation likelihood may be considered. This refers to modeling which other nodes should receive the people leaving a given node in the following time step. A transition function may, for example, model this movement as part of a series of random walks. Note that individuals are not modeled over time in this approach, but for purposes of discussing this algorithm it can be useful to consider a number of temporary, hypothetical people equal to the number of departures. For each such hypothetical person departing a given node, they are given an equal chance of moving to a node that is reachable from their previous node in the flow network. More specifically, the number of people moving in each direction may be drawn from a multinomial distribution based on the number of people attempting to depart (according to the steps in the previous section) and a simplex describing the relative probability of direction.

A transition function may also, for example, model departures as a random vector, translating the result to the nearest node in flow model in the chosen direction at the chosen distance.

The transition distribution may also, for example, model individuals or groups of people, each with goals that they move towards. Such an approach may approximate real behavior with higher fidelity. However, there are two downsides to such an approach:
Modeling individuals would likely complicate the state space model, as discussed in a previous section.
There is the potential that introducing such complexity would result in overfitting, demanding that goals and motions be very carefully modeled to avoid being overly prescriptive.

Note that the state space model should potentially model every possible reality, and Sequential Monte Carlo methods will generally evaluate these realities' likelihoods as a distinct step. An overly prescriptive model transition distribution might be incapable of creating certain realities, meaning that predictions matching them could never be generated, no matter what the observations indicated. Therefore, it may be preferable for the state space model to remain as simple as possible during the initial distribution and transition distribution modeling, only adopting additional complexity when necessary. This is especially important given that human behavior is seldom fully constrained by space or rules and a model such as those described here.

Congestion Modeling

In practice, people don't always move through spaces at their physical top speeds. Crowding, for example, can be a factor: as the number of people in an area increases, each person's movement speed through that space tends to decrease. Given the desired applications of the present invention around supporting the safe and efficient movement of people, this is a practical consideration that it may be desirable to model. Modeling congestion may help the simulation more accurately reflect actual patterns of motion.

Once again, it is desirable to avoid modeling individual people for complexity reasons. There are several approaches that may be used to model congestion, while still allowing the state space to remain tractable. One possible approach, for example, is presented here:
1) For each node, based on:
   the occupancy of that node,
   the cumulative time of people in that node, and
   the prior knowledge of how long people may want to want to stay in the node, a series of binomial draws are used to determine the number of people trying to depart the node (see Departure Rates, above)
2) Based on the number of departing people, a multinomial distribution is used to determine which of the available node destinations they will attempt to depart to, with each possible destination being equally likely. This is in keeping with the “random walk” notion described above, but other approaches as possible.
3) For each destination node, there is a count Wₓ of people waiting to go to that node. This number is increased at a given time step based on the number of people chosen to go to that destination node.
4) Each edge departing from this node will have a capacity C modeled in the flow model: this determines the number of people who can move between the two connected nodes during each time step. This capacity is shared for people moving in each direction, so in the case of a bidirectional edge where people from nodes A and B each want to move to the other opposite node, a hypergeometric distribution is used to iteratively select up to C people from the two nodes to move to their destination, based on the values of WA and WB.
5) After all capacity has been used, there may still be nonzero numbers of W values in some nodes. Those values persist between time steps and may build up over time if a large number of people are trying to leave a node with limited outgoing capacity.

The result of this process is a transition distribution that efficiently models bottlenecks between areas, which will realistically generate scenarios where people remain in an area even when there is no modeled reason for them to “want” to stay, which is a natural consequence of many crowded areas.

This helps the state space keep from drifting too quickly. If there are a very large number of people observed in an area, realities where they spontaneously all move to nearby spaces aren't realistic. The result of such an approach would be a less useful set of generated spaces and the potential for more erratic, less accurate externalized estimates.

State Space Model: Observation Distribution

The initial and transition distributions make up the core of the state space model. Sequential Monte Carlo methods then rely on a third distribution to evaluate various realities, so that more useful ones can be practically identified and extrapolated: the observation distribution.

Modeling Sensor Data

During the creation of the flow model, the locations and properties of sensors may be specified. An algorithm may then translate these details into a notion of sensor coverage: each node in the flow model's network contains information about which sensors can report occupancy about it. For each such node-sensor pair, there may be a probability that the sensor will detect a person in that node. This reflects, for example, that a sensor might be very likely to detect a person near the sensor, but may be more likely to miss them as their distance from the sensor increases. These coverage-generating algorithms may be designed on a per-sensor type basis; examples include but are not limited to:
An RFID reader may have a distribution, where nodes near the sensor have a high probability of detection, falling off as the distance increases.
A video camera may have a viewport polygon indicated in the model, which will overlap with some number of nodes, indicating that the camera can detect people in those nodes. This viewport may help to capture that cameras have a particular facing, may have obstructed views of spaces, and otherwise have nuances that make a simple normal radius of detection insufficient. Once again, there may be areas at the far end of the viewable area that have a lower chance of detection.
A wifi access point may use assumptions about the space and distances between other wifi access points to assess which nodes represent locations where a person's devices are likely to connect to that access point, as opposed to another access point on the network.

When sensor data is received, this may be applied in terms of these coverage mappings. Once again this may be done in a sensor-specific manner. Examples include but are not limited to:
Sensor data may be uniformly applied across its coverage area, representing a lack of specific knowledge about where people are placed. For example, a sensor covering 8 nodes that detected 4 people may simply indicate an identical normal distribution for each of those 8 nodes, each centered around a mean of one half of a person.
In the case of an RFID reader or other sensor with a more likely “center” of nodes, the nodes' distributions may be adjusted so that the more likely nodes would be more likely to report a proportionally higher number of people.

In the simplest case, the sum of the probabilities in the nodes for a sensor will total the number of people detected by that sensor, with some room for variation within each node.

It may be desirable to assume that each sensor is imperfect and to model sensor error. In cases where prior knowledge about the error rates of sensors is present, a hyperparameter may be used to adjust occupancy probabilities for that sensor. For example, if a sensor is known to only detect 80% of people within its range, when it detects 4 people the simulation may distribute probabilities totaling 5 people to the nodes it covers. The amount of adjustment may itself be the subject of some uncertainty: the proportion of people to be added may be a normal distribution centered around an error rate, with a standard deviation that increases as uncertainty about the error rate itself does.

In some cases, it may be beneficial to assign “virtual coverage” within areas by assuming that people are uniformly distributed within them. For example, if there is a sensor that covers half of a room and detects 5 people, the system may extrapolate that there are, on average, 10 people in the room. Some examples of possible extensions of this idea include:
This extrapolation may be subject to error, and certainty about the distribution of people in the room may be used to widen the standard deviation of the distribution of people to add
Certainty about the number of people in the uncovered parts of a virtually-covered area may also vary depending on the number of people detected. For example, if one person is detected in a space that can hold 100, there may reasonably be 2-4 times that many people in the rest of the room, whereas when 30 people are detected such high coefficients may become less likely.
Uniform distribution was presented as an example in the name of clarity, but the distribution of people need not be assumed to be uniform. If prior knowledge is available that suggests a different spatial distribution for a room, it can be applied in a similar fashion.

This sensor model may then be used to take data from various sensors over the course of a time step and translate it into a flow model-based probability of peoples' location in space. This spatial probability of locations is called the observation distribution for that time step.

Applying Observation Distributions

Once sensor data has been expressed in terms of the flow model's nodes, it may be compared to the probabilistic locations of people expressed by a state space model's state. This may be used to determine the probability of a state given the observations made by various sensors. This is achieved via the application of Bayes rule:

$$P ( A \vert B ) = \frac{P ( B \vert A ) P ( A )}{P ( B )}$$

Where, in various embodiments of the present invention:
A=a real state
B=a set of observations
P(A|B)=the probability of a state, given probabilistic observations (the goal of the system)
P(B|A)=the probability of a given observation, given a probabilistic underlying state (this is what the output of the observation distribution expresses)
P(A)=priors: a distribution of knowledge of the state (this is what the state space model creates via its initial and transition distributions)
P (B)=prior generalized knowledge about all observations. Because this will be the same for all states, and the system is only interested in the relative weights of states for purposes of nominating them for continued development (their actual absolute probability isn't interesting), this can be ignored as a practical consideration.

Therefore, in short, the system may arrive at a joint probability distribution by adding the log probability distributions that are output by an observation distribution and a state space model. This method may be used as part of a sampling process, enabling the system to approximate the whole of the possible spaces and their likelihoods at a given time step, even though they cannot be practically modeled directly. This can, in turn, then be used to guide the reporting of results to users, informing them of the most likely actual states of their space, and the overall certainty of estimates.

Fusing Unidentified Data Sources

A benefit of this process is that data from multiple unidentified data sources can be combined to form a unified influence on our state space model's evolution. The mechanisms by which this is achieved warrant further discussion.

Consider, for example, a camera that reports detections every 30 seconds, and a wifi integration that reports detections from all access points in the space once every minute. Given a 15 second time step duration, there may be time steps where both or neither data sources provide data, as well as time steps where video detections are present, but not wifi detections, or vice versa. Various embodiments of the present invention enable fusion in each of these cases:
In the case where neither data source provides detections, SMC simulation can continue with an empty observation distribution without disruption: states will only have the probabilities attached to them via the transition distribution, and will move forward naively into the next step.
In the case where both data sources provide detections, the system can perform in-step fusion. In cases where data sources' coverage areas do not overlap, distributions can simply be summed. In cases where there is overlap, the shared coverage of a given node may be used to reduce the probability of the number of people in that node, reflecting that two data sources may have collectively double-counted the same person. The exact mechanism for this reconciliation may vary, and may be informed by the results of offline simulations of the space (as discussed in a later section). As an example of a simple realization of this concept, each node may have its distributions from all sources totaled, and then divided by the number of contributing sources.
In the case where only one data source contributes to a time step, the sequential Monte Carlo method enables those data sources to be “in conversation” with one another. For example, when the video integration is alone in contributing to a time step, it will direct the weighting of possible realities according to its observations. This will indirectly affect the set of realities that are available for the wifi integration to influence when it next provides detections, which it may itself do on a time step in which there are no video detections reported. The result is a set of realities that, on average, will not be too different from what either data source dictates is likely to be occurring in the space.

This latter scenario warrants highlighting: achieving consensus between data sources that may not be actively reporting data at similar cadences is a novel contribution of the present invention.

Identified Data Sources

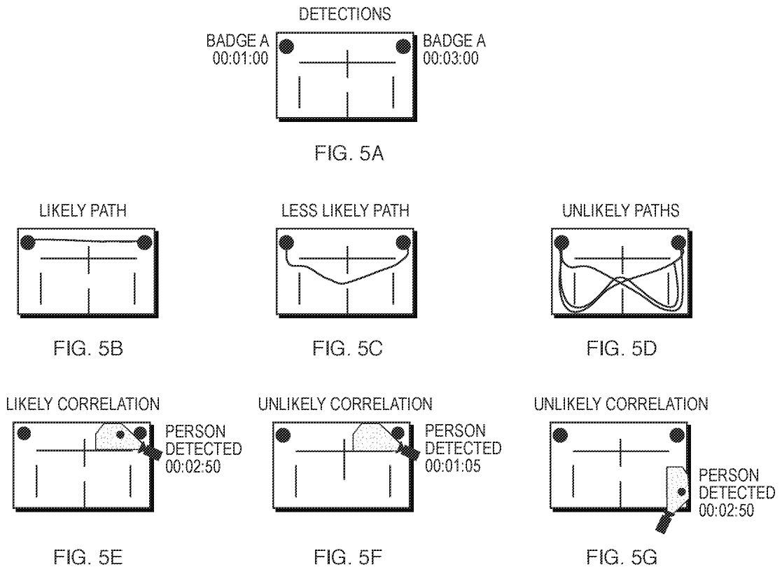

The discussion thus far has focused on unidentified data sources: those that anonymously indicate a number of people. One advantage of embodiments of the present invention is that they are also able to take advantage of individual-specific data from data sources that consistently identify people over time, without expanding the state space model to account for individuals, ensuring that analyzing it remains tractable. As an example, FIGS. 5A-5G are illustrations of likely paths and double-counting detecting correlations according to one embodiment of the present invention.

To illustrate the benefits of this approach, consider a building where RFID readers have been installed, through which people carry their own individually-identifiable RFID badges. Suppose a sensor observes that Badge A was detected at the northwest corner of a building, and that it was detected 2 minutes later at the northeast corner (see subfigure A in the figure above). If the building is of a size that walking that distance would normally take about 2 minutes, it is possible to make several inferences about the person carrying that badge:
They were likely occupying locations in between those two locations, along navigable paths, at various points between those two moments in time. The more direct routes can be modeled as more likely (see B, above), and other, longer routes are less likely but possible (C, D). It is hypothetically possible, for example, that the person navigated to an additional destination in the southeast corner of the building on their way to the northeast corner.
If other anonymous data sources detected a person in the intervening areas during this timespan, there is a chance that those data sources detected this same person, and we can mitigate double-counting them (E)
This person can be assumed not to have been present in other parts of the building that couldn't have feasibly been reached given their observation at these two points. Any observations of people in those locations can be considered independent with greater confidence (F, G).

These may appear to be minor insights, but when extrapolated across a large number of people, and considered alongside any number of other data sources, the impact can be significant. Through methods that support inferences of this kind, the system may be able to understand where people are, even while they are not being directly observed, beyond what would be possible with unidentified data sources alone.

One example of an approach to this problem is as follows:
Maintain a time window of recent observations, which can be considered holistically.
For all data sources that apply identifying information, coalesce that identifying information into tags that exist during this time window.
For each tag compose a probabilistic complete path that expresses where a person associated with that tag might be over time.
Use these complete paths to probabilistically coalesce those tags into identities representing a single person.
Apply these probability distributions to create a single distribution of total occupancy in the space over time, as informed by all identified data sources.

This combined identified data source may then be treated as an unidentified data source and compared to unidentified data sources via the mechanisms described above. Crucially, this data source's probability distributions are informed by identified information over time, and may provide much higher confidence and enable stronger inferences to be made.

One example of a method by which these steps are achieved are described in the following sections.

Time Windows

A benefit of considering identified data sources is that they enable multiple time steps to be used in conjunction to draw stronger inferences about how detections map to peoples' locations, and where those people might be in between said detections. Therefore, the data structure used to make inferences is a series of time steps, rather than a single time step as with unidentified data sources.

The number of time steps considered at a time may vary: longer windows will allow for stronger inferences, but will create larger data structures and more computationally intensive searches. The selection of this number may be influenced by the distance between identity-enabled sensors and the expected amount of time between identified detections: it can be helpful if the window is long enough to consistently capture multiple instances of the same person. A window of 20 time steps, each 15 seconds long, may be considered a sensible baseline.

Tags

A tag refers to any piece of identifying information attached to a sensor detection that may be used to associate that detection with a specific person, and that might be consistently observed over time. Tags may be specific to a particular data type: wifi sensor detections may have a set of tags that are disjoint from those of an RFID reader or video analysis feed. Examples of tags include:
An RFID, Bluetooth or IoT reader reporting the same identification from a badge or device
An associated wifi integration reporting the same device's MAC address
A video analysis system detecting a person with a particular visual signature, in terms of facial recognition or simpler attributes such as clothing color or gender, and then detecting a person with a similar signature on another camera
An unassociated wifi integration reporting sets of probe data, where the MAC addresses are not consistent, but a similar metadata signature is found on the packets. Detecting multiple packets with similar such derived attributes would imply a common sender, and could be used to associate those packets with a common tag.

Note that in the first two cases, the matter of equality is fairly straightforward: the RFID and associated wifi tags are simple text strings and will either match exactly or not at all. The latter two examples may involve fuzzier matches, as some detections may share similar features and could be considered the “same” with a varying degree of certainty. However, the reconciliation of these fuzzy matches may be considered out of the scope of the present invention: each integration may be expected to provide unique identifiers for detections that it considers the same. The system may ingest these identifiers and attach a degree of certainty to the tags, which may then be fed forward into the probabilistic establishment of identifiers as discussed in the following section.

Identities

The previous step explained how detections over time, within the same data source, may be connected via tags. These tags may be linked to people in a data source-agnostic manner, forming identities. The goals of this process include:
Improving the system's ability to infer where a person has traveled, by fusing tag-based data points from across multiple sources
Improving the system's count estimates, by identifying cases when multiple tags from the same data source might represent redundant signals from a single person

Complete Paths

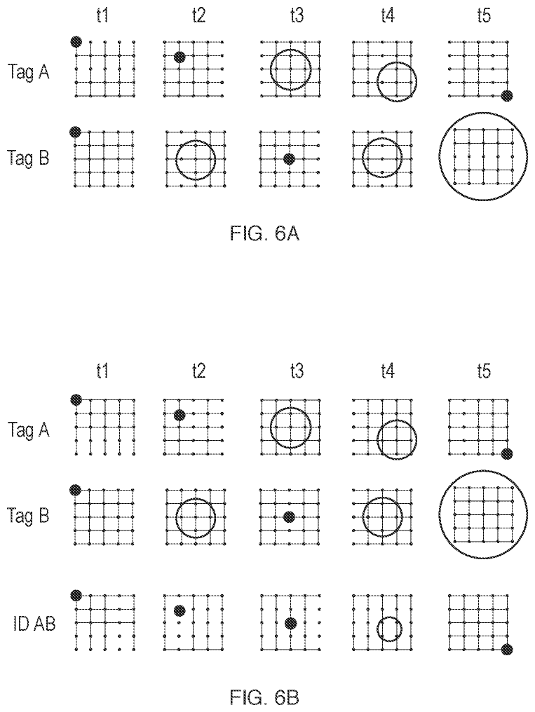

As discussed previously, data sources cannot necessarily be relied upon to report detection data on every time step. This is especially relevant when it comes to comparing tags: it may be beneficial to compare the locations of tags across data sources, which may be reporting data on disjoint cadences. To enable comparison between these tags, all tags within a time window may be converted into a complete path. Each such path may contain, for each time step, a probability of the tag being present in each node in the flow model's network. These complete paths may facilitate comparing tags. For example, FIG. 6A is an illustration of the possible locations of two tags over the course of five time steps according to one embodiment of the present invention.

Various methods are possible to generate complete paths; one possible approach is outlined as an example here. This example refers to Tag A and Tag B in FIG. 6A. Note that this diagram uses a simplified grid, but in practice the underlying graph would consist of the actual nodes and navigable edges of the flow model's network, and the paths may be much more constrained. The example approach may be summarized as follows:
1) For each time step where a tag was detected, identify a single mode node in which the tag was most likely to be. This step applies to timesteps 1, 2, and 5 for Tag A and timesteps 1 and 3 for Tag B. We can call these tag-time step pairs sightings.
2) For each gap of time between sightings, find the possible paths between the nodes on either side of the gap. Use these paths to determine the nodes that the tag might be in during the intervening steps. The longer it has been between sightings, the more widely distributed the possible paths will be, and the more diffuse the probabilities will be.
   a) In the case where there are time steps after the last sighting (as with Tag B), the generation of these paths will not be governed by an endpoint and will be equally likely to move in every possible direction outward from the last sighting.
   b) In each case, the sum of the probabilities within a time step will be one.
3) For each sighting step, replace the single mode node with the actual probability distribution of the tag (not shown above).

The process of finding (and later replacing) a mode node is intended to simplify the calculation of intervening paths between sightings. By focusing on a single source and destination nodes, a variety of path-finding graph algorithms may be used to find possible routes between nodes, and therefore probabilities between steps, in an efficient manner. This approach also ensures that the number of likely routes is finite. As a consequence, if calculating paths between sightings at run-time were to be found to be too computationally expensive, the various embodiments of the present invention may pre-generate and index all possible paths (and therefore probabilities) for each combination of sources, destinations, and durations. Two additional notes about this example method follow:
In some cases, the location probability during a sighting may be multi-modal, and multiple possible mode nodes could be generated and extrapolated from.
The mode-finding approach may, in some cases, unduly constrain the search space of possible paths. Other more complex methods are possible and the mode-based approach is presented only as an example to demonstrate the tractability of this aspect of the present invention.

Composing Identities from Tags

The problem of associating tags with one another can be framed as a search problem: the system's goal is to find pairs of tags that have the highest likelihood of being associated with the same person. A great many existing search methods may be applied to a search problem such as this as long as a distance metric between candidate elements is provided. In the case of the present invention, because of the work done in generating completed paths, a simple approach such as this one, provided as an example, may be applied:
For each time step, a given pair of complete paths will always have a probability density expressed in terms of the nodes of the flow model's network. The system may calculate the log probability of a person being in a location that satisfies both tags by comparing the probabilities of all non-zero probability nodes.
The system may then sum the (log) probabilities of all time steps to find the overall likelihood of overlap.

A few additional notes on this approach:
The exact similarity threshold for combining tags into an identity may vary for different situations; it may be expressed as a hyperparameter for the system, which may be derivable via simulation.
It may be desirable to express additional prior knowledge about how tags may be combined. For example, a normal distribution of the number of wifi-enabled devices a person is carrying may be defined. For example, a distribution with a mean of two devices would reflect that a person could reasonably be carrying a phone and wearing a smartwatch, and would enable a few such tags to be combined, but would reduce the chance of, for example, fifteen wifi tags being associated into a single identity.
The possibility that tags represent a shared identity may itself be represented probabilistically, and may be used to modulate the certainty of resulting identity paths.

In the example of Tag A and B above, the system might reasonably conclude that the tags in question were carried by a single person, and might combine them into a single identity.

Application

Once a set of identities has been derived, the system may derive a set of complete paths describing each:
In the case of tags that were not associated with any other tags, their complete path can be used directly
For all identities composed of multiple tags, those tags' paths' probabilities for each location in time and space can be summed, creating a combined, higher-certainty measure of a given person's location over time

An example of the latter case is illustrated in FIG. 6B: if it is determined that Tag A and B refer to a single person, the identity path of that person may be informed by both tags, and may be much more tightly constrained as a result: each tag's more-precise location is used when possible. The example depicted above is a simplification, because it depicts the mode locations rather than the proper densities of possible locations at each sighting step, but the principle is the same.

The result of this process is a series of complete paths, each of which may be assumed to represent a single person. These paths each have a certainty associated with them, which is derived from the certainty that the tags composing the paths represent a single identity, combined with the probabilistic locations of each of those tags. Extrapolating these higher-level representations, while still capturing the uncertainty of the underlying assumptions, is critical to using the representations effectively.

These probabilistic paths may then be added together to create a probability distribution of likely occupancies across the simulation. This final step abandons individual identities to generate an unidentified probability distribution akin to those discussed previously. This distribution may then be combined with other unidentified data sources as part of the system's final occupancy calculations. This previous-identified-now-unidentified data source has several advantages with respect to accuracy:
By linking tags' locations over time, the system is able to arrive at complete paths that more closely model individuals actual locations at each time step, leading to more accurate estimate locations
This effect is amplified when tags are combined into identities: in some cases' peoples' locations can be much more precisely determined than with unidentified data sources alone
By leveraging tags and their locations over time, the system is better able to recognize situations where multiple detections represent the same person, resulting in more accurate counts in the final occupancy distribution

This approach to identified data is a novel aspect of the present invention. Methods such as those discussed here enable the system to access and combine all of the information from various data sources, even when they are disparate in type and disjoint in time.

Considering Additional Data Sources

The simulation's observation function and evaluation of states may also be supported by guidance from sources other than sensors. For example, contextual information such as planned events, weather, or traffic data may inform the likelihood of particular states. This information may be leveraged in several ways. For example, the data may be modeled in terms of areas in the flow model and the expected occupancy at particular times. For example, a room with an event planned with an expected attendance of 100 people would be modeled as an occupancy distribution covering the room's areas as represented in the flow model. This information about expected occupancy could also cover one or more entire spaces.

During the times that the event is scheduled, that occupancy distribution could be considered as part of the observation distribution function's evaluation. This may be performed by finding the joint probability distribution of the occupancy expectations occupancy distribution and other data sources' distributions.

Contextual information may also be used to find similarities between multiple occasions. If two occasions are shown to be similar (for example, if they have similar events scheduled, weather predictions, or traffic conditions) evaluations of one occasion may be used to influence the evaluation of the other. Once again, the evaluation of one state's occupancy will be represented as an occupancy distribution and fused with other data sources' distributions as part of the observation function. This may be especially valuable when the system has more certainty about one of the occasions than the other. For example, the system may have high certainty about the occupancy of an area on an occasion in the past, because it is able to leverage data from before, during and after the occasion. A similar occasion in the future will not be as easy to assess owing to reduced access to sensor data, and the system may benefit from knowledge derived from its comparison to the previous occasion. These examples have described comparisons between two occasions for simplicity; comparisons between a larger plurality of occasions may also be performed.

Spaces may be identified as similar to each other. This assessment of similarity may, for example, be based on similarities in the spaces' purpose, layout, expected population, size, or other qualities. This similarity may also, for example, be based on similarities in the spaces' respective sensor or contextual data. When spaces have been identified as similar, knowledge about one such space may be used to influence the analysis of others. This knowledge may be expressed in terms of hyperparameters on the spaces' simulations. For example, accumulated knowledge about how many people tend to carry wifi-connected devices in sports, corporate, or academic settings may be modeled in analyses of spaces of those kinds. This knowledge may be expressed in terms of simulations' observation functions. For example, a space's observation function could include a distribution that increases the chance of people being in eating areas at typical meal times, based on observations of similar spaces' areas and patterns of life.

An additional example of influencing the observation function with non-sensor data is considering human-provided observations. A person may directly or indirectly indicate their belief that an area or space has a particular occupancy, and this belief can be represented as an occupancy distribution for the space and time in question. This may then be fused with other data sources' distribution as part of the observation function.

Finally, note that the previous discussions have focused on sensors within the space itself. However, sensors outside the space may also inform a space's occupancy. For example, a sensor detecting the number of cars in a parking garage may detect that a large number of cars were recently parked. If this parking garage were primarily used by occupants of the monitored space, this would suggest an impending influx of people into the space. Furthermore, those people would be most likely to use the entrance into the space that is closest to the parking garage being monitored. This information may once again be modeled via occupancy distributions as part of the observation function. A distribution may, for example, increase its probability of high occupancy near entrances and exits based on changes in parking garage usage, offset in time to account for the time people spend traveling between the parking garage and the monitored space. The probability distribution of occupancy change, time offset, and locations of impacted areas may be manually specified, and may be guided by direct observations and/or the result of offline simulations.

Similarly, while spaces will often be considered in isolation of one another, it is possible for changes in one space to affect the analysis of another. For example, if two spaces are near one another, people departing one space in a particular direction may be assumed to be arriving at the other space. This information may once again be modeled via occupancy distributions as part of the observation function. A distribution may, for example, increase its probability of high occupancy near entrances and exits based on changes in nearby spaces, offset in time to account for the time people might spend traveling between the spaces. The probability distribution of occupancy change, time offset, and locations of impacted areas may be manually specified, and may be guided by direct observations and/or the result of offline simulations.

Offline Agent-Based Simulation

The simulation component of the various embodiments of the present invention may be improved by including hyperparameters that guide its operation, or by refinements to probability distributions or other functions that govern its movement between states. One possible approach to finding these hyperparameters and distributions is to run an agent-based offline simulation. A simulation of this kind is different from previously discussed simulation-based methods in one primary way: rather than trying to use multiple realities to hypothesize about the unknown locations of real people, it creates a single reality with hypothetical people, with exact simulated locations that are known to the software. The goal of this latter simulation is not to directly solve a real world problem, but to approximate real world scenarios so that they can be observed and learned from. Information gathered from these full-information scenarios can then be modeled to improve other simulations and analyses.

Because Sequential Monte Carlo-based simulations and similar simulation-based analysis approaches focus on exploring an entire space of possible realities, that space must be carefully controlled. One of the major consequences of this demand is that individual people usually cannot be directly modeled. By comparison, an offline simulation may focus on highly-detailed individual agents representing people in the space: these agents can have individual schedules, desires, and pathfinding behaviors. In addition, complex interactions between simulated people, such as crowding for example, may be modeled.

An offline simulation may run on the same virtual digital twins that later live simulations will use, enabling observations to be translated between them. An offline simulation may model virtual sensors and patterns by which they detect virtual people. Possible methods for leveraging the offline simulation include:
Improving a state space model's transition distribution by:
   deriving per-area congestion parameters based on collision-aware movement
   validating person motion rates by visualizing their emergent effects
Improving identify-enabled data modeling by:
   finding thresholds for coalescing tags into identities
   finding likely underlying distributions for the number of devices people are carrying, given particular patterns in detected devices
   informing the complete path generation process by modeling the most common routes between locations
Improving flow models by:
   identifying connections between nodes in the digital twin that, while physically traversable, are unlikely be used given the emergent properties of the space. Such links might be given lower weights for selection during the transition distribution, or may be removed altogether
   informing how various overlapping sensors are likely to interact

In summary, offline simulations may be used to gather grounded data about emergent effects that would otherwise be more naively estimated, resulting in increased accuracy.

Presenting Results

Finally the various embodiments of the present invention may output results in a user-readable format, providing them with useful insights and other benefits. There are many possible methods by which this may be achieved, including, for example:
A map of the space being monitored may be displayed, with areas colored based on their likelihood of having a higher occupancy at a particular moment in time.
A table listing various areas of interest to the user may be displayed. In each row, various statistics describing the space's occupancy may be displayed. In addition, colors, graphs, and other visualizations may be embedded in the table to provide insights into the areas' occupancy.
Various reports summarizing the occupancy of various spaces and areas may be displayed. These may depict categorical aggregations of statistics, or depict changes to occupancy and other values of interest over time.

In each case, an expression of the system's evaluation may involve an element of certainty. Because the various embodiments of the present invention may operate in terms of probabilities of particular states, it is possible to provide output that goes beyond presenting a single definitive answer. Possible representations of results may include, for example:
Displaying a map that represents the occupancy of various areas, as well as the certainty that those occupancy estimates are correct. Multiple visual channels such as color, opacity, hue, saturation and/or border weight may be used to display these dimensions simultaneously.
Including a certainty value alongside the numerical values presented in maps, tables, reports, and other expressions of results.
Displaying multiple possible maps, tables, or reports, each representing a possible assessment of a space, with a probability attached to each.

It is to be understood that although the invention has been described above in terms of particular embodiments, the foregoing embodiments are provided as illustrative only, and do not limit or define the scope of the invention. Various other embodiments, including but not limited to the following, are also within the scope of the claims. For example, elements and components described herein may be further divided into additional components or joined together to form fewer components for performing the same functions.

Any of the functions disclosed herein may be implemented using means for performing those functions. Such means include, but are not limited to, any of the components disclosed herein, such as the computer-related components described below.

The techniques described above may be implemented, for example, in hardware, one or more computer programs tangibly stored on one or more computer-readable media, firmware, or any combination thereof. The techniques described above may be implemented in one or more computer programs executing on (or executable by) a programmable computer including any combination of any number of the following: a processor, a storage medium readable and/or writable by the processor (including, for example, volatile and non-volatile memory and/or storage elements), an input device, and an output device. Program code may be applied to input entered using the input device to perform the functions described and to generate output using the output device.

Embodiments of the present invention include features which are only possible and/or feasible to implement with the use of one or more computers, computer processors, and/or other elements of a computer system. Such features are either impossible or impractical to implement mentally and/or manually. For example, embodiments of the presentation generate and update (in some cases in real-time) simulations of physical spaces based on input receive. Such a function is inherently rooted in computer technology and cannot be performed mentally or manually.

Any claims herein which affirmatively require a computer, a processor, a memory, or similar computer-related elements, are intended to require such elements, and should not be interpreted as if such elements are not present in or required by such claims. Such claims are not intended, and should not be interpreted, to cover methods and/or systems which lack the recited computer-related elements. For example, any method claim herein which recites that the claimed method is performed by a computer, a processor, a memory, and/or similar computer-related element, is intended to, and should only be interpreted to, encompass methods which are performed by the recited computer-related element(s). Such a method claim should not be interpreted, for example, to encompass a method that is performed mentally or by hand (e.g., using pencil and paper). Similarly, any product claim herein which recites that the claimed product includes a computer, a processor, a memory, and/or similar computer-related element, is intended to, and should only be interpreted to, encompass products which include the recited computer-related element(s). Such a product claim should not be interpreted, for example, to encompass a product that does not include the recited computer-related element(s).

Each computer program within the scope of the claims below may be implemented in any programming language, such as assembly language, machine language, a high-level procedural programming language, or an object-oriented programming language. The programming language may, for example, be a compiled or interpreted programming language.

Each such computer program may be implemented in a computer program product tangibly embodied in a machine-readable storage device for execution by a computer processor. Method steps of the invention may be performed by one or more computer processors executing a program tangibly embodied on a computer-readable medium to perform functions of the invention by operating on input and generating output. Suitable processors include, by way of example, both general and special purpose microprocessors. Generally, the processor receives (reads) instructions and data from a memory (such as a read-only memory and/or a random access memory) and writes (stores) instructions and data to the memory. Storage devices suitable for tangibly embodying computer program instructions and data include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits) or FPGAs (Field-Programmable Gate Arrays). A computer can generally also receive (read) programs and data from, and write (store) programs and data to, a non-transitory computer-readable storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

Any data disclosed herein may be implemented, for example, in one or more data structures tangibly stored on a non-transitory computer-readable medium. Embodiments of the invention may store such data in such data structure(s) and read such data from such data structure(s).

Any step or act disclosed herein as being performed, or capable of being performed, by a computer or other machine, may be performed automatically by a computer or other machine, whether or not explicitly disclosed as such herein. A step or act that is performed automatically is performed solely by a computer or other machine, without human intervention. A step or act that is performed automatically may, for example, operate solely on inputs received from a computer or other machine, and not from a human. A step or act that is performed automatically may, for example, be initiated by a signal received from a computer or other machine, and not from a human. A step or act that is performed automatically may, for example, provide output to a computer or other machine, and not to a human.

The terms “A or B,” “at least one of A or/and B,” “at least one of A and B,” “at least one of A or B,” or “one or more of A or/and B” used in the various embodiments of the present disclosure include any and all combinations of words enumerated with it. For example, “A or B,” “at least one of A and B” or “at least one of A or B” may mean: (1) including at least one A, (2) including at least one B, (3) including either A or B, or (4) including both at least one A and at least one B.

What is claimed is:

1. A method for generating a representation of predicted occupancy in a particular space, the method performed by at least one computer processor executing computer program instructions stored in at least one non-transitory computer-readable medium, the method comprising:
(A) applying a plurality of sensors within the space that generate sensor data associated with a plurality of times and spaces;
(B) generating a flow model based on a digital representation of the particular space, wherein the flow model includes traversability patterns representing the flow of people into, out of, and within the particular space over time;
(C) generating a set of initial states and selecting the set of initial states as a current set of states;
(D) simulating occupancy of the particular space, starting from the current set of states and using the flow model, to produce a plurality of subsequent states, wherein each of the plurality of subsequent states indicates a corresponding estimation of occupancy within the particular space; and
(E) using the sensor data to evaluate a subset of the plurality of subsequent states, wherein the estimations of occupancy corresponding to the subset of the plurality of subsequent states are associated with a plurality of times and spaces that are not within the times and spaces associated with the sensor data in step (A), thereby identifying highly-evaluated states within the plurality of subsequent states.

2. The method of claim 1, further comprising:
(F) providing the highly-evaluated states identified by (E) as a current set of states to (D), repeating (D) and (E), and outputting the highly-evaluated states produced by the most recent iteration of (E).

3. The method of claim 1, wherein (A) is performed before (B)-(E), and wherein (B)-(E) are applied to the sensor data generated in (A) and not to any additional sensor data.

4. The method of claim 1, wherein the plurality of sensors includes at least one video camera, and wherein the sensor data includes: (1) a plurality of images output by the at least one video cameras and (2) locations of detected people in the plurality of images, as generated by analytics run on the images.

5. The method of claim 4, wherein the plurality of sensors further includes at least one Wi-Fi-sensing sensor, and wherein (E) comprises using the plurality of images output by the plurality of video cameras, the locations of detected people in the plurality of images, and i-Fi signal data from the Wi-Fi-sensing sensors to evaluate the subset of the plurality of subsequent states.

6. The method of claim 4, wherein the plurality of sensors further includes at least one RFID sensor, and wherein (E) comprises using the plurality of images output by the plurality of video cameras, the locations of detected people in the plurality of images, and tag detection from the at least one RFID sensor to evaluate the subset of the plurality of subsequent states.

7. The method of claim 1, wherein the plurality of sensors includes at least one Wi-Fi access point, and wherein the sensor data includes data about communication of at least one device with the at least one Wi-Fi access point.

8. The method of claim 1, wherein the plurality of sensors includes at least one Wi-Fi sensor, and wherein the sensor data includes data about Wi-Fi signals detected by the at least one Wi-Fi sensor.

9. The method of claim 1, wherein the plurality of sensors includes at least one RFID sensor, and wherein the sensor data includes data about nearby RFID tags generated by the at least one RFID sensor.

10. The method of claim 1, wherein the plurality of sensors includes at least one motion sensor, and wherein the sensor data includes motion detection events generated by the at least one motion sensor.

11. The method of claim 1, wherein the plurality of sensors includes at least one carbon dioxide sensor, and wherein the sensor data includes carbon dioxide readings generated by the at least one carbon dioxide sensor.

12. The method of claim 1, wherein the plurality of sensors includes at least one sound sensor, and wherein the sensor data includes sound level readings generated by the at least one sound sensor.

13. The method of claim 1, wherein the plurality of sensors includes at least one ultra-wideband sensor, and wherein the sensor data includes object detection data generated by the at least one ultra-wideband sensor.

14. The method of claim 1, wherein the plurality of sensors includes at least one access control badge sensor, and wherein the sensor data includes badge detection events generated by the at least one badge detection sensor.

15. The method of claim 1, wherein (E) comprises using the sensor data and data about events that are planned in the particular space to evaluate the subset of the plurality of subsequent states.

16. The method of claim 1, wherein (E) comprises using the sensor data and predictions about weather in the particular space's location to evaluate the subset of the plurality of subsequent states.

17. The method of claim 1, wherein (E) comprises using the sensor data and public transportation schedules governing arrivals to and departures to locations near the particular space to evaluate the subset of the plurality of subsequent states.

18. The method of claim 1, wherein generating the flow model in (B) comprises generating a graph representing the particular space, with graph nodes representing locations in the particular space and links between them representing the ability for people to move from one location to another in the particular space.

19. The method of claim 1, wherein the flow model comprises a uniform representation of the particular space that locates data from sensors with different spatial coverage and sensing capabilities to be fused in the evaluation in (E).

20. The method of claim 2, wherein the flow model comprises a sensor-agnostic representation of the particular space, enabling the form of the highly-evaluated states produced by the most recent iteration of (E) to be independent of limitations of individual ones of the plurality of sensors.

21. The method of claim 1, wherein the simulating in (C) is informed by prior knowledge about qualities of the particular space and similarities of the particular space to previously analyzed spaces.

22. The method of claim 1, wherein the simulating in (C) comprises simulating the occupancy of the space using Sequential Monte Carlo simulation.

23. The method of claim 1, wherein the simulating in (C) is informed by hyperparameters derived from offline simulations that model individual, artificially intelligent agents that move within the particular space.

24. The method of claim 1, wherein simulating in (C) is informed by hyperparameters modeling human-observed ground truth about the occupancy of the particular space being simulated.

25. The method of claim 1, wherein producing the plurality of subsequent states comprises applying a probability distribution describing likely movements of people between locations in the particular space.

26. The method of claim 25, wherein the probability distribution incorporates prior knowledge about how people enter and leave the particular space.

27. The method of claim 25, further comprising generating the probability distribution based on prior knowledge about maximum flow rates that are possible between areas in the particular space.

28. The method of claim 25, further comprising generating the probability distribution based on prior knowledge about occupants' typical goals and preferred navigation paths in the particular space.

29. The method of claim 25, further comprising generating the probability distribution based on prior knowledge about how crowding affects occupants' possible movements in the particular space.

30. The method of claim 1, wherein using the sensor data to evaluate the subset of the plurality of subsequent states comprises finding a joint probability distribution of the plurality of subsequent states and an observation probability distribution that summarizes the sensor data.

31. The method of claim 1, wherein using the sensor data to evaluate the subset of the plurality of subsequent states comprises combining information about individual occupants' likely locations in the particular space over time with anonymous data within the sensor data.

32. The method of claim 2, wherein outputting the highly-evaluated states comprises generating, for each of the plurality of subsequent states, a probabilistic certainty of that state representing an actual state of the particular space's occupancy.

33. The method of claim 2, wherein outputting the highly-evaluated states comprises providing a human-interpretable representation of a likely actual occupancy of the particular space.

34. The method of claim 2, wherein outputting the highly-evaluated states comprises providing a representation of a likely actual occupancy of the particular space as soon as sufficient data is available.

35. The method of claim 2, wherein outputting the highly-evaluated states comprises providing a representation of a likely actual occupancy of the particular space during a particular time period retroactively, based on data that arrived before, during, and after the time period.

36. The method of claim 1, wherein the plurality of sensors includes at least one sensor that senses an area not physically located within the space being monitored, and wherein the sensor data includes data that indirectly indicates occupancy in the space.

37. A system comprising at least one non-transitory computer-readable medium having computer program instructions stored thereon, wherein the computer program instructions are executable by at least one computer processor to perform a method for generating a representation of predicted occupancy in a particular space, the method comprising:
(A) applying a plurality of sensors within the space that generate sensor data associated with a plurality of times and spaces;
(B) generating a flow model based on a digital representation of the particular space, wherein the flow model includes traversability patterns representing the flow of people into, out of, and within the particular space over time;
(C) generating a set of initial states and selecting the set of initial states as a current set of states;
(D) simulating occupancy of the particular space, starting from the current set of states and using the flow model, to produce a plurality of subsequent states, wherein each of the plurality of subsequent states indicates a corresponding estimation of occupancy within the particular space; and
(E) using the sensor data to evaluate a subset of the plurality of subsequent states, wherein the estimations of occupancy corresponding to the subset of the plurality of subsequent states are associated with a plurality of times and spaces that are not within the times and spaces associated with the sensor data in step (A), thereby identifying highly-evaluated states within the plurality of subsequent states.
